(19) United States
(12) Patent Application Publication
(10) Pub. No.: US 2012/0142557 A1
(43) Pub. Date: Jun. 7, 2012

(54) SLIDE CONDITIONING SYSTEMS AND METHODS

(75) Inventors: Dale B. Emery, Salt Lake City, UT (US); Nils B. Adey, Salt Lake City, UT (US)

(73) Assignee: Roche NimbleGen, Inc., Madison, WI (US)

(21) Appl. No.: 13/257,483

(22) PCT Filed: Mar. 17, 2010
(86) PCT No.: PCT/US10/27690

§ 371 Date: Dec. 6, 2011

Related U.S. Application Data
(60) Provisional application No. 61/160,993, filed on Mar. 17, 2009.

(51) Int. Cl. C40B 40/00; C40B 60/00

(52) U.S. Cl. 506/13; 506/33

(57) ABSTRACT

A slide-loader system for preparing a microarray slide having a hybridized reaction area for washing, and which includes an immersion tray which contains a volume of wash buffer fluid, and a stripping jig that holds the microarray slide during removal of a reaction chamber housing that is mounted about the hybridized reaction area.

### PRIORITY CLAIM

This application claims the benefit of U.S. Provisional Patent Application Ser. No. 61/160,993, filed Mar. 17, 2009, which is incorporated by reference.

### FIELD OF THE INVENTION

The present invention relates generally to systems for use in conditioning slides. More particularly, the invention relates to systems for washing microarray slides.

### BACKGROUND OF THE INVENTION

Microarray hybridization is a well-known technique used in detecting whether a specific nucleic acid resides in a given sample. This technique generally includes the immobilization of known nucleic acid sequence probes on a glass slide, followed by introduction of the sample media to the probes in order to determine whether the sample contains any complementary nucleic acid sequence. When matching sequences are found, the presence of an indicator confirms the match.

Processing a hybridization slide for later analysis typically can require a significant number of process steps, including forming a reaction chamber around the portion of the slide containing the array of immobilized reactant probes, filling the reaction chamber with the mobile reactant specimens in solution, hybridizing the specimens with the probes during an incubation step, and washing away the un-hybridized fluid sample from the microarray slide upon completion of the incubation phase. Each of these phases should be completed without damaging the hybridized reactant samples.

While many technical challenges are presented by each of these phases, the washing phase in particular has proved problematic in past efforts. The washing phase should be completed in a thorough and efficient manner, cleaning all portions of the slide, including the side edges. One example of a specific wash system may be found in Applicant's co-pending U.S. patent application Ser. No. 12/247,408, which is incorporated herein by reference.

One challenge of many wash systems is the mechanism, or lack thereof, for handling slides. In short, slides must be loaded into the wash system in a safe, quick, and effective manner. Because the slides are most often made of glass, and are most often used in a wet environment, there is a potential hazard of slide loss or damage due to dropping or other accident while being handled by a user. In many cases, there is also a risk of injury to the user by the sharp edges which form when a glass slide is broken.

### SUMMARY OF THE INVENTION

In accordance with one embodiment describing herein, a slide-loader system is provided for preparing a microarray slide having a hybridized reaction area for washing. The slide-loader system includes an immersion tray which contains a volume of wash buffer fluid, and a stripping jig that holds the microarray slide during removal of a reaction chamber housing that is mounted about the hybridized reaction area. The system also includes a slide carrier having an open top and one or more holding slots that are accessible through the open top and which receive the microarray slide after removal of the reaction chamber housing. The slide-loader system further includes an indexing device which both couples the slide carrier to the stripping jig and aligns the microarray slide with the holding slot. The indexing device, slide carrier and stripping jig together form a loader assembly that is installed into the immersion tray so that the microarray slide is substantially immersed in the wash buffer fluid during removal of the reaction chamber housing and insertion into a holding slot.

In accordance with another embodiment describing herein, a method is provided for processing a microarray slide having a hybridized reaction area for washing in a slide conditioning system. The method includes the steps of obtaining a stripping jig having a slotted passage formed therein and which is operably coupled to an indexing device, and coupling a slide carrier to the indexing device to form a loader assembly, with the slide carrier having an open top and a holding slot accessible through the open top that is aligned with the slotted passage by the indexing device. The method also includes the steps of installing the loader assembly into an immersion tray containing wash buffer fluid and inserting the microarray slide having a reaction chamber housing mounted about the hybridized reaction area into the slotted passage. The method further includes removing the reaction chamber housing while the microarray slide is substantially immersed in the wash buffer fluid, moving the microarray slide into the holding slot of the slide carrier which is filled with a quantity wash buffer fluid, and separating the slide carrier and the included microarray slide from the indexing device without releasing the quantity of wash buffer fluid.

In accordance with yet another embodiment describing herein, a method is provided for processing one or more microarray slides having a hybridized reaction area for washing in a slide conditioning system. The method includes the step of obtaining a stripping jig having a slotted passage formed therein for holding the microarray slides, each of which has a reaction chamber housing mounted about the hybridized reaction area. The method also includes operably coupling a slide carrier to the stripping jig, with the slide carrier having an open top and one or more holding slots accessible therethrough, and where the holding slots are aligned one at a time with the slotted passage. The method further includes substantially submerging the slide carrier and coupled stripping jig within an immersion tray containing wash buffer fluid, inserting one or more microarray slides, one at a time, into the slotted passage, removing the reaction chamber housings with the microarray slides substantially immersed in the wash buffer fluid, and moving the microarray slides into the holding slots of the slide carrier which is filled with a quantity of wash buffer fluid. The method also includes the steps of removing the slide carrier and coupled stripping jig from the immersion tray containing wash buffer fluid and separating the slide carrier and the included microarray slide from the stripping jig without releasing the quantity of wash buffer fluid.

There has thus been outlined, rather broadly, the more important features of the invention so that the detailed description thereof that follows may be better understood, and so that the present contribution to the art may be better appreciated. Other features of the present invention will become clearer from the following detailed description of the invention, taken with the accompanying drawings and claims, or may be learned by the practice of the invention.

### BRIEF DESCRIPTION OF THE DRAWINGS

FIG. 1 is a schematic view of a process for conditioning a microarray slide having a hybridized reaction area, in accordance with one representative embodiment;

FIG. 2 is a perspective view of a slide-loader system, in accordance with another representative embodiment;

FIG. 3 is a side view of a loader assembly, in accordance with the slide-loader system of FIG. 2;

FIG. 4 is a side view of an upright stripping jig and indexing device, in accordance with the slide-loader system of FIG. 2;

FIG. 5 is a side view of an upright slide carrier, in accordance with the slide-loader system of FIG. 2;

FIG. 6 is a close-up view of the slide carrier being coupled into the indexing device;

FIG. 7 is a side view of the upright assembled loader assembly;

FIG. 8 is a perspective view of the loader assembly installed in an immersion tray containing wash buffer fluid, in accordance with the slide-loader system of FIG. 2;

FIG. 9 illustrates the step of inserting at a microarray slide into the slotted passage, in accordance another representative embodiment;

FIG. 10 illustrates the step of removing the reaction chamber housing with the microarray slide, in accordance with the embodiment of FIG. 9;

FIG. 11 illustrates the step of moving the microarray slide into the slide carrier, in accordance with the embodiment of FIG. 9;

FIGS. 12A and 12B together illustrate the step of separating the slide carrier and the included microarray slide from the stripping jig and indexing device, in accordance with the embodiment of FIG. 9;

FIG. 13 illustrates the step installing the slide carrier and the included microarray slide into a centrifugal slide conditioning system cradle, in accordance with yet another representative embodiment; and

FIG. 14 is a flowchart depicting a method of processing a microarray slide for washing in a slide conditioning system, in accordance with one representative embodiment.

### DETAILED DESCRIPTION

The following detailed description makes reference to the accompanying drawings, which form a part thereof and in which are shown, by way of illustration, various representative embodiments in which the invention can be practiced. While these embodiments are described in sufficient detail to enable those skilled in the art to practice the invention, it should be understood that other embodiments can be realized and that various changes can be made without departing from the spirit and scope of the present invention. As such, the following detailed description is not intended to limit the scope of the invention as it is claimed, but rather is presented for purposes of illustration, to describe the features and characteristics of the representative embodiments, and to sufficiently enable one skilled in the art to practice the invention. Furthermore, the following detailed description and representative embodiments of the invention will best be understood with reference to the accompanying drawings, wherein the elements and features of the embodiments are designated by numerals throughout.

### DEFINITIONS

In describing and claiming the present invention, the following terminology will be used in accordance with the definitions set forth below.

As used herein, the term “microarray slide” refers to a slide substrate having a reaction area containing an arrayed series of thousands of microscopic spots of immobilized biological reactants or probes. In one aspect, for example, a DNA microarray can comprise features that contain a specific nucleic acid sequence. This can include a short section of a gene or other DNA element that is used as a probe that can hybridize to a cDNA or cRNA sample (sometimes called the target) under the proper conditions. In standard microarrays, probes can be covalently coupled to a solid substrate surface such as glass or silicon.

Microarray slides may also be used in the diagnostic testing of sample types other than DNA samples, and microarray probe locations may be formed of various large biomolecules, such as DNA, RNA, and proteins, smaller molecules such as drugs, co-factors, signaling molecules, peptides or oligonucleotides. Moreover, while it is typical to immobilize known reactants on the substrate, expose an unknown liquid sample to the immobilized reactants, and query the reaction products in order to characterize the sample, it is also possible to immobilize one or more unknown samples on the substrate and expose them to a liquid containing one or more known reactants.

As used herein, the term “hybridized reaction area” refers to the reaction area of a microarray slide which has been exposed to a solution containing mobilized sample media to determine whether the sample media includes any molecules that are complimentary with the immobilized reactants. Fluorescent indicators can be attached to the sample media, so that the hybridized reaction area can later be queried or analyzed using a fluorescence microscope or similar slide reader. With DNA-based hybridization, for instance, the mobilized sample media may comprise complementary nucleic acid sequences, and when matching sequences are found, the fluorescent indicators can appear to confirm the match and determine the relative abundance of specific nucleic acid sequences.

As used herein, the term “reaction chamber housing” refers to a removable chamber or mixer assembly that in one aspect can be made from a plastic or polymeric material and mounted around the portion of the microarray slide containing the array of immobilized reactant probes, and which can be filled with the mobilized reactant specimens in solution to hybridize the specimens with the probes during an incubation step. The reaction chamber housing can also be disposable after removal from the microarray slide

As used herein, the term “wash buffer fluid” refers to one or more liquids configured to remove and dilute the sample media solution from off the surface of the microarray slide without altering or harming the hybridized reaction area.

As used herein, the term “substantially” refers to the complete or nearly complete extent or degree of an action, characteristic, property, state, structure, item, or result. As an arbitrary example, an object that is “substantially” enclosed is an object that is either completely enclosed or nearly completely enclosed. The exact allowable degree of deviation from absolute completeness may in some cases depend on the specific context. However, generally speaking the nearness of completion will be so as to have the same overall result as if absolute and total completion were obtained.

The use of “substantially” is equally applicable when used in a negative connotation to refer to the complete, or nearly complete, lack of an action, characteristic, property, state, structure, item, or result. As an arbitrary example, a composition that is “substantially free of” particles would either completely lack particles, or so nearly completely lack particles that the effect would be the same as if it completely lacked particles. In other words, a composition that is “substantially free of” an ingredient or element may still actually contain such item as long as there is no measurable effect thereof.

As used herein, the term “about” is used to provide flexibility to a numerical range endpoint by providing that a given value may be “a little above” or “a little below” the endpoint.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 2, 3, 4, and 5, individually. This same principle applies to ranges reciting only one numerical value as a minimum or a maximum. Furthermore, such an interpretation should apply regardless of the breadth of the range or the characteristics being described.

Relative directional terms such as “upwardly,” “downwardly” and/or “vertically” are sometimes used herein in order to describe the present invention in the most straightforward manner. It is to be understood that such terms are not intended to narrow the invention and should not be construed in any limiting manner.

### Embodiments of the Invention

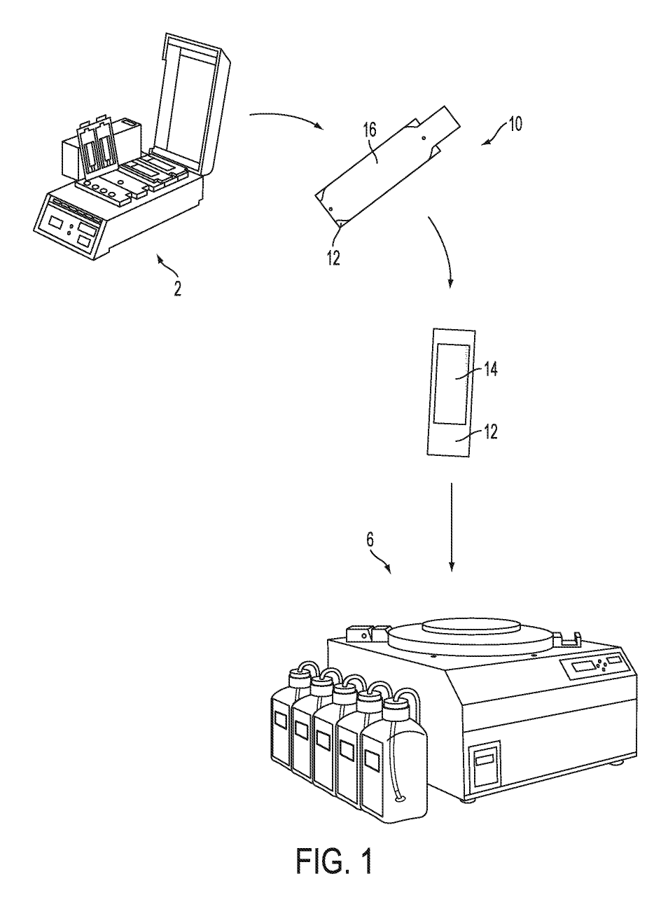

Illustrated in FIGS. 1-14 are several representative embodiments of a slide-loader system for preparing a microarray slide having a hybridized reaction area for washing, which embodiments also include various methods for processing a microarray slide having a hybridized reaction area for washing in a slide conditioning system. As described below, the slide loader system provides several significant advantages and benefits over other devices and methods for preparing hybridized microarray slides for washing. However, the recited advantages are not meant to be limiting in any way, as one skilled in the art will appreciate that other advantages may also be realized upon practicing the present invention.

FIG. 1 is a schematic view of a process for conditioning or cleaning a microarray slide 10 having a hybridized reaction area 14, and which includes removing the microarray slide from a hybridization/incubation system, such as the representative four-position hybridization unit 2 shown in FIG. 1, and removing a reaction chamber shell or housing 16, also known as a mixer, that is mounted to the substrate 12 of the hybridization slide around the reaction area 14. The microarray slide 10 is then installed into a cleaning or slide conditioning system 6, such as the representative automated centrifugal wash/spin-dry system, for the cleaning and stripping away of the residual sample media solution and drying of the microarray slide prior to placement into a fluorescence microscope or slide reader for query and analysis.

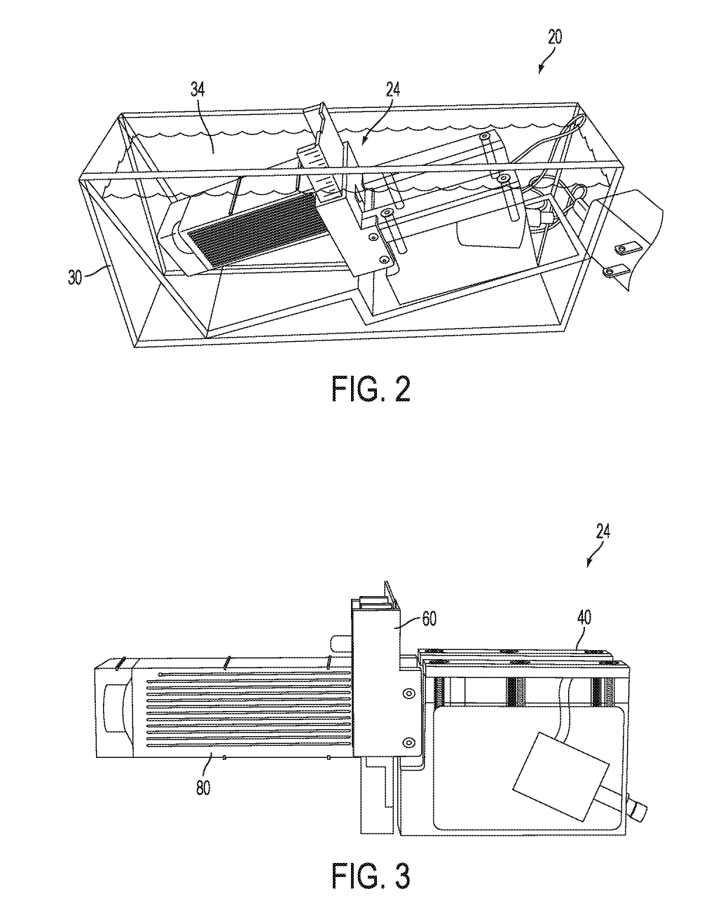

Illustrated in FIG. 2 is a representative slide-loader system 20 for removing the reaction chamber shell or housing from off the microarray slide. The slide loader system 20 includes a loader assembly 24 and an immersion tray 30 filled with wash buffer fluid 34, and which can be sized and configured for placement on a desk top or lab bench for easy access and operation by a lab technician. The slide-loader system 20 can be advantageous by providing for the removal of the reaction chamber housing and placement of the microarray slide inside a slide conditioning system with minimal contact with the hands of the technician and little to no exposure of the hybridized reaction area to the ambient air, thereby reducing the risk of damage and contamination.

One embodiment of the loader assembly 24 is shown in more detail in FIG. 3, and includes a stripping jig 40, an indexing device 60 and a slide carrier 80. The three components can be assembled together so that the slide carrier 80 moves relative to the stripping jig 40 in a controlled manner, as provided by indexing device 60. The loader assembly can be used in the angled or prone orientations, as shown in FIGS. 2 and 3, and can be assembled or disassembled in the vertical or upright position.

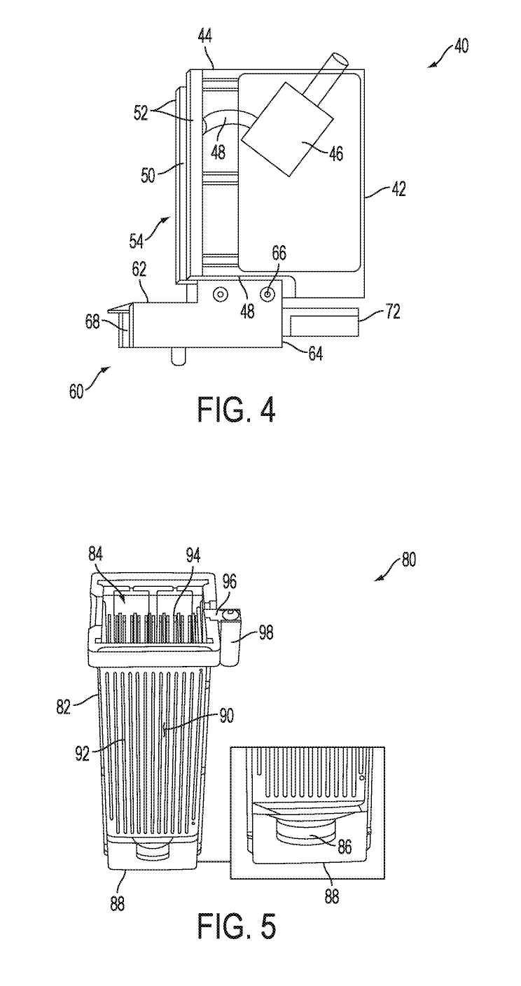

Referring now to FIG. 4, the stripping jig 40 can comprises a hollow body 42 having an inlet end 44, an outlet end 48, and a slotted passage 50 formed into an upper side of the body. In the embodiment illustrated, the slotted passage 50 can be formed from two side rails 52 with notches or grooves 54 facing and aligning with each other to define the slotted passage 50, and which grooves can be configured to loosely hold the long edges of a microarray slide that is slidably inserted therein. Thus, the gap between the two side rails can also provide the slotted passage with an open face through which the top surface of the installed microarray slide can be accessed. In one aspect of the stripping jig 40, a submersible pump 46 can be located within the hollow body 42, with the pump outlet being fluidly connected with nozzles formed into the side rails 52 so that an activated pump can create a continuous flow of wash buffer over the top surface of the installed microarray slide.

Also illustrated in FIG. 4 is the indexing device 60, which can comprise a fixed outer guide 62 having an inner end 64 and an outer end 68, and which is securely mounted to the outlet end 48 of the stripping jig 40 with bolts or screws 66. A sliding cartridge 72 can be slidably installed within the outer guide 62, and can be configured to lightly “lock” at periodic discrete positions that are separated by predetermined intervals as it is moved back and forth within the outer guide 62. For example, the locking mechanism can comprise one or more spring-loaded indexing tabs (not shown) formed into either or both sides of the outer guide or the sliding cartridge, and which fits into any of a plurality of complimentary openings (also not shown) formed into the other component, as may be appreciated by one of skill in the art. The spring-loaded indexing tabs can be configured to release from one opening and allow the sliding cartridge to move to the next position relative to the stripping jig 40 under the application of finger pressure to one end or the other, until the tab snaps into the next corresponding opening.

The slide carrier 80 of the loader assembly is shown separately in FIG. 5, and can comprise a container body 82 having an open top 84, a closed bottom 88, and which is generally adapted to carry one or more microarray slides. For example, in one aspect the slides can be loaded into the slide carrier 80 and maintained in a spaced-apart relationship by way of a plurality of notches 92 formed into the inside surfaces of the side walls 90 of the slide carrier 80 to create one or more slide-holding slots 94. Once the desired number of slides has been loaded, a lid (not shown) can optionally be placed over the open top 84 of the slide carrier 80 prior to being installed into the slide conditioning system.

In another aspect, the slide carrier can include an agitation bar 96. The agitation bar 96 can be operable to agitate the microarray slides by moving the slides slightly within the holding slots 94 to thereby prevent materials from collecting in the spaces between the slides and the walls of notches 92 and sides 90 of the carrier body 82. The agitation bar 96 can also aid in preventing the creation of “dry spots” between the microarray slides and the notch walls or walls of the slide carrier. The agitation bar 96 can include a connection interface or agitation bar tab 98 that interfaces with an actuation mechanism within the centrifugal slide conditioning system 6 (see FIG. 1) for automated agitation of the micro array slide during the washing process.

The slide carrier 80 can optionally include a bi-directional valve 86 formed into the closed bottom 88, and which can take a variety of forms. In one aspect, the valve 86 is operable to retain fluid within the carrier 80 while subject to ambient conditions, and is operable to allow fluid to flow from the carrier when the carrier is subject to centrifugal forces, such as those which can be applied by the slide conditioning system. One manner in which this can be accomplished is by providing the valve in the form of a polymeric septum having one or more slits formed therein. This configuration has been found to adequately retain fluid within the slide carrier when under atmospheric conditions (e.g., during handling when loading the carrier with slides or while transporting the slide carrier from a slide-loader station to the slide conditioning system). However, other configurations and devices for allowing fluid to be retained within the slide carrier or to allow fluid to alternately flow into and out of the slide carrier are also contemplated and considered to fall within the scope of the present invention.

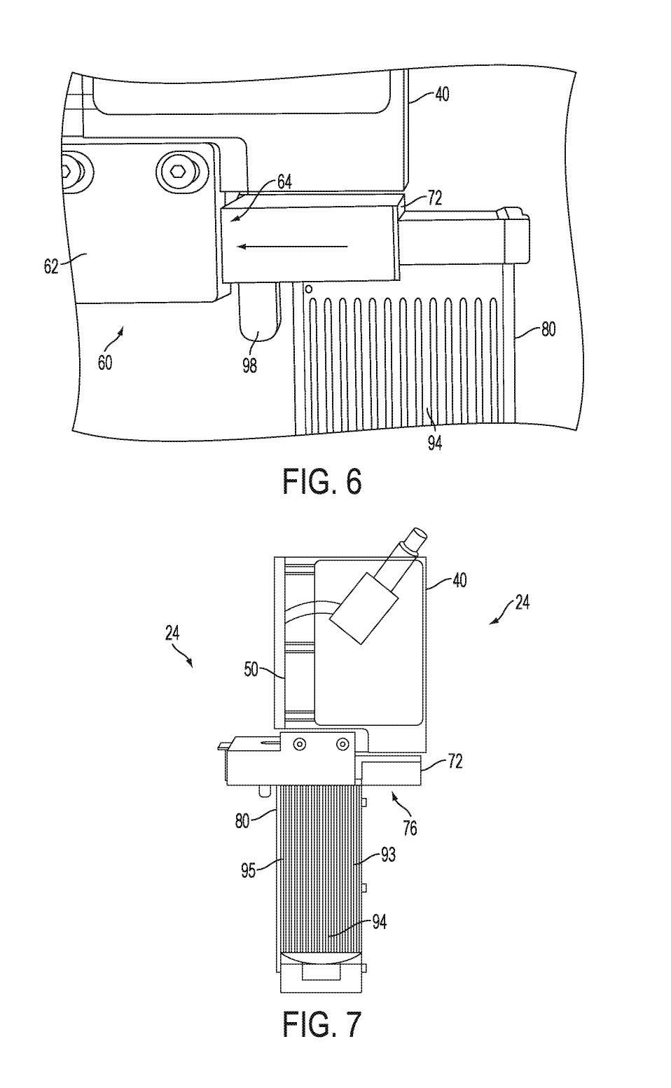

Illustrated in FIG. 6 is step of attaching the slide carrier 80 to the indexing device 60 and stripping jig 40 so that the slots 94 in the slide carrier align with the slotted passage in the disassembly device. In the representative embodiment of the loader assembly shown and described herein, the upper portion of the slide carrier 80 can interface with and slide into the sliding carriage 72 of the indexing device 60 adjacent the inner end 64 of the fixed guide 62, and with the agitation bar tab 98 in the forward position. Once reaching its fully-engaged position with the sliding carriage, the slide carrier can be locked into place relative to the sliding carriage 72 with a spring-loaded locking tab 76, as shown in FIG. 7, to complete the loader assembly 24. One assembled, moreover, the slide carrier 80 and sliding carriage 72 can move together as a unit relative to the stripping jig 40 and fixed outer guide 62 of the locking device, so that the slots 94 in the slide carrier 80 can be aligned one at a time with the slotted passage 50 in the stripping jig 40. As can also be seen in FIG. 7, the last slot 95 in the slide carrier 80 is aligned with the slotted passage 50, while the first slot 93 in the slide carrier is under the center of the stripping jig.

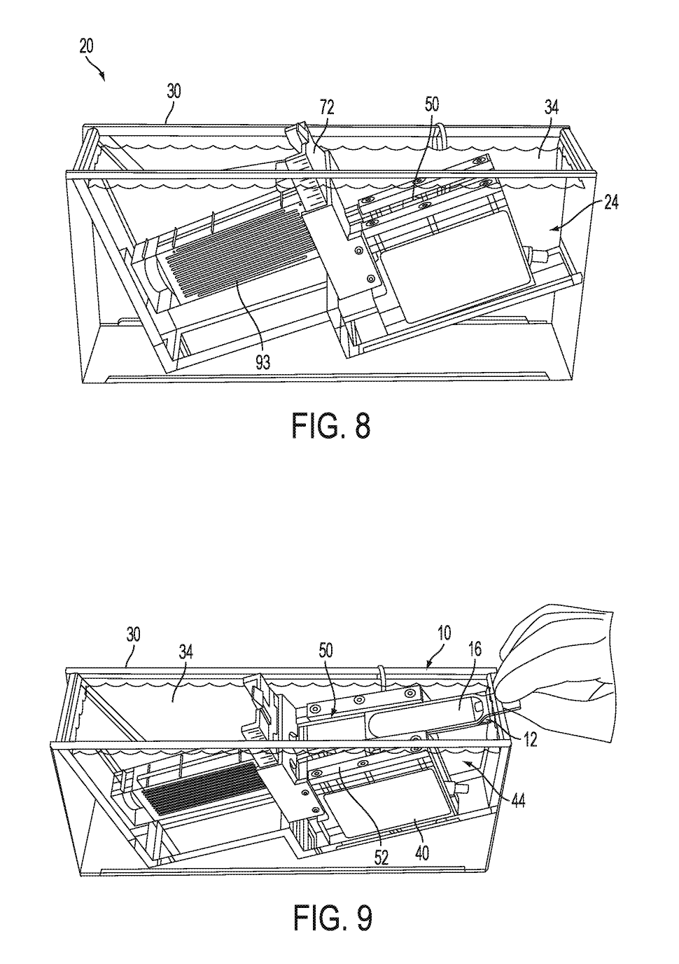

Referring now to FIG. 8, the sliding carriage 72 can then be moved to its further forward position, with the first slot 93 in the slide carrier aligned with the slotted passage 50, and the loader assembly 24 can be installed into the immersion tray 30 that is filled with wash buffer fluid 34 to complete the assemblage of the slide-loader system 20. In one aspect the wash buffer fluid can be heated, and can fill the immersion tray to about ½ inch from the top prior to installation of loader assembly.

A microarray slide 10 having a reaction chamber housing 16 mounted about a hybridized reaction area can then be inserted into the inlet end 44 of the slotted passage 50, as shown in FIG. 9. The notches or grooves 54 in the side rails 52 can be of sufficient depth to hold the long edges of the slide substrate 12 against any vertically-applied forces (e.g. perpendicular to the plane of the slide substrate), while being of sufficient width to allow the substrate to slide easily in the axial direction (parallel to the long axis of the slide substrate). Because the stripping jig 40 and slotted passage 50 are completely submerged within the bath of buffer fluid 34 contained within the immersion tray 30, the installed micro array slide 10 is also substantially immersed with the buffer fluid once inserted all the way into the slotted passage 50.

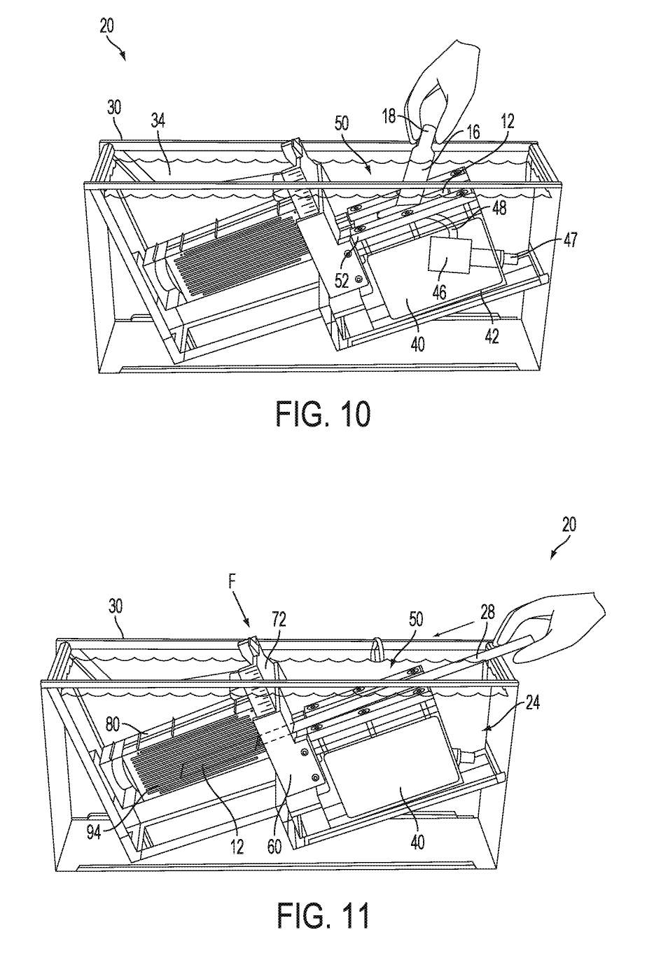

Illustrated in FIG. 10 is the step of removing the reaction chamber housing 16 from off the slide substrate 12 to expose the hybridized reaction area 14 to the buffer fluid 34. In the representative embodiment shown, this can comprise grasping a tab 18 of the reaction chamber housing or mixer 16 which extends beyond a short edge of the slide substrate, and pulling it upwards and away from the microarray slide to break an adhesive seal holding the housing to the slide substrate, and to peel the reaction chamber housing or mixer 16 from about the reaction area. As the reaction chamber housing 16 is peeled away from the slide substrate 12 via the open face of the slotted passage 50, the buffer fluid can immediately flow into the resulting space and prevent any exposure of the hybridized reaction area with the ambient air, thereby greatly reducing the risk of contaminating the reaction area with airborne particles and other pollutants, etc. The relatively large volume of buffer fluid contained with the immersion tray, which can be about 700 ml, in comparison to the very small amount of sample media solution contained within the reaction chamber, which can be less than about 100 μl, may also serve to dilute the sample media solution to an essentially insignificant concentration.

As described above, in one aspect of the slide-loader system 20 a pump 46 having a suction inlet 47 can be installed within the hollow body 42 of the stripping jig 40 and with an pump outlet being fluidly coupled to inwardly-directed fluid channels or nozzles formed into the side rails 52, and which can provided a continuous flow of buffer fluid over the top surface of the slide substrate 12. The continuous flow of buffer fluid provided by the pump can serve to better flush sample the media solution from off the hybridized reaction area 14 in preparation for complete cleaning in the slide conditioning system. For convenience purposes the pump can be submersible and installed within the hollow body 42 of the stripping jig so as to maintain the tubing connection with the nozzles when the stripping jig is removed from the immersion tray. However, it is to be appreciated that other embodiments of the slide-loader system having the pump located exterior to the immersion tray and with inlet/discharge tubing connections to a suction inlet inside the immersion tray and to the side rail nozzles, respectively, are also possible and considered to fall within the scope of the invention.

As shown in FIG. 11, after the reaction chamber housing has been removed from about the hybridized reaction area the microarray slide can then be moved from the slotted passage 50 to one of the holding slots 94 inside the slide carrier 80, which is also submerged with the immersion tray 30 and filled with buffer fluid. With the indexing device 60 configured to align the slotted passage with one of the holding slots, the slide substrate 12 can then be pushed through indexing device and into the holding slot with either a finger or a push bar 28 or similar device, etc. In one aspect the push bar 28 can have substantially the same width and thickness of the slide substrate 12, but with considerably longer length, and can also be used to verify the alignment between the holding slot 94 in the slide carrier 90 and the slotted passage 50 in the stripping jig 40 prior to installing the microarray slide 10. Verifying that the holding slot and slotted passages are properly aligned prior to insertion of the microarray slide into the loader assembly can greatly reduce or eliminate the risk of unintended removal of the microarray slide and exposure of the uncovered reaction area to the surrounding environment caused by misalignment that prevents the slide substrate from being moved directly into the slide carrier after removal of the reaction chamber housing.

After the microarray slide 10 with an uncovered reaction array is moved into one of the holding slots 94, the slide carrier 80 can be moved a discrete distance within the indexing device 60 to align another holding slot with the slotted passage 50 of the stripping jig 40, so that the process of removing a reaction chamber housing from another submerged microarray slide can be repeated. In the representative embodiment of the loader assembly 24 shown and described herein, this can be accomplished by pressing gently downward on the exposed outer end of the sliding carriage 72 of the indexing device with force F until the internal spring-loaded indexing tabs (not shown) release from the present openings and allow the sliding cartridge 72 to move or index to the next position relative to the stripping jig 40 and snap into place in the next corresponding set of openings. If fewer microarray slides are to be cleaned and processed in the conditioning system than available holding slots 94 in the slide carrier, one or more indexing positions and holding slots can be skipped before processing the next hybridized microarray slide, so as to maximum the space between slides stored in the slide carrier.

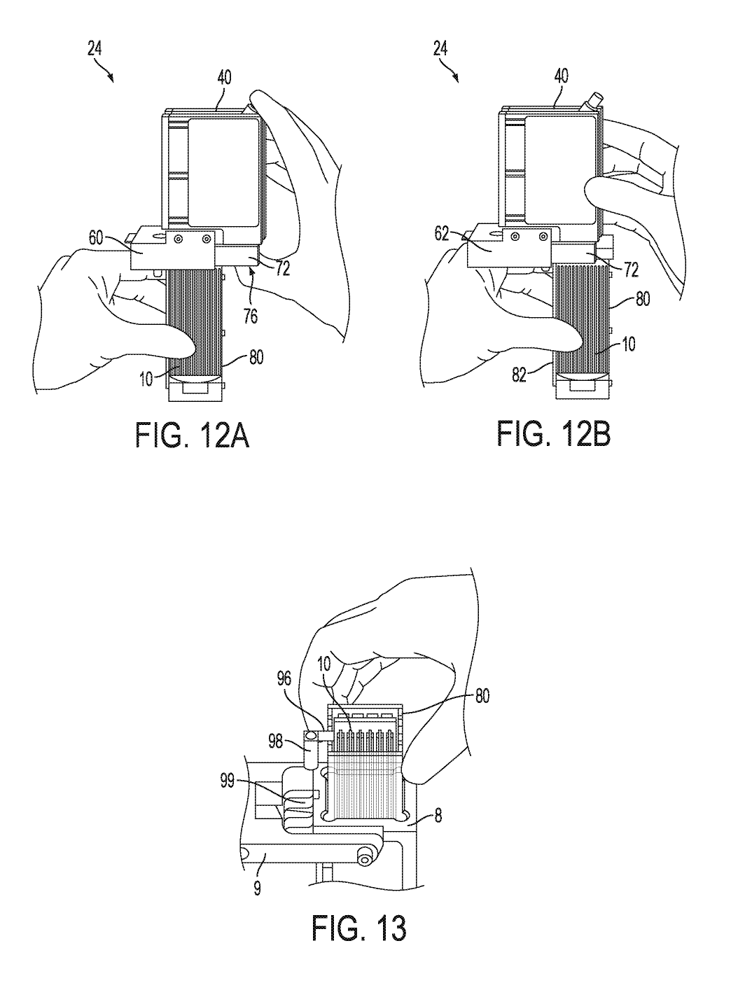

After the desired number of microarray slides having hybridized reaction areas have been processed with the slide-loader system 20, the loader assembly 24 can be removed from the immersion tank 30 and orientated vertically with the slide container 80 below the indexing device 60 and stripping jig 40, as shown in FIGS. 12A and 12B. The slide container 80 can then be released from the indexing device by pushing up on the spring-loaded locking tab 76 formed into the sliding carriage 72, and carefully sliding the top portion of the slide carrier 80 laterally out from within the sliding carriage. This can be accomplished without spilling or releasing the quantity of wash buffer fluid that is being held within the container body 82 and protecting the exposed reaction areas of the hybridized microarray slides 10.

With reference now to FIG. 13, the slide carrier 80 and included microarray slides 10 can then be installed into a cradle 8 formed into one end of a rotating arm 9 in the centrifugal slide conditioning system. As can also be seen, the agitation bar tab 98 or connection interface for the agitation bar 96 in the slide carrier can interface with an actuation mechanism 99 located within the centrifugal slide conditioning system 6 (see FIG. 1) for automatic agitation of the microarray slide during the cleaning process.

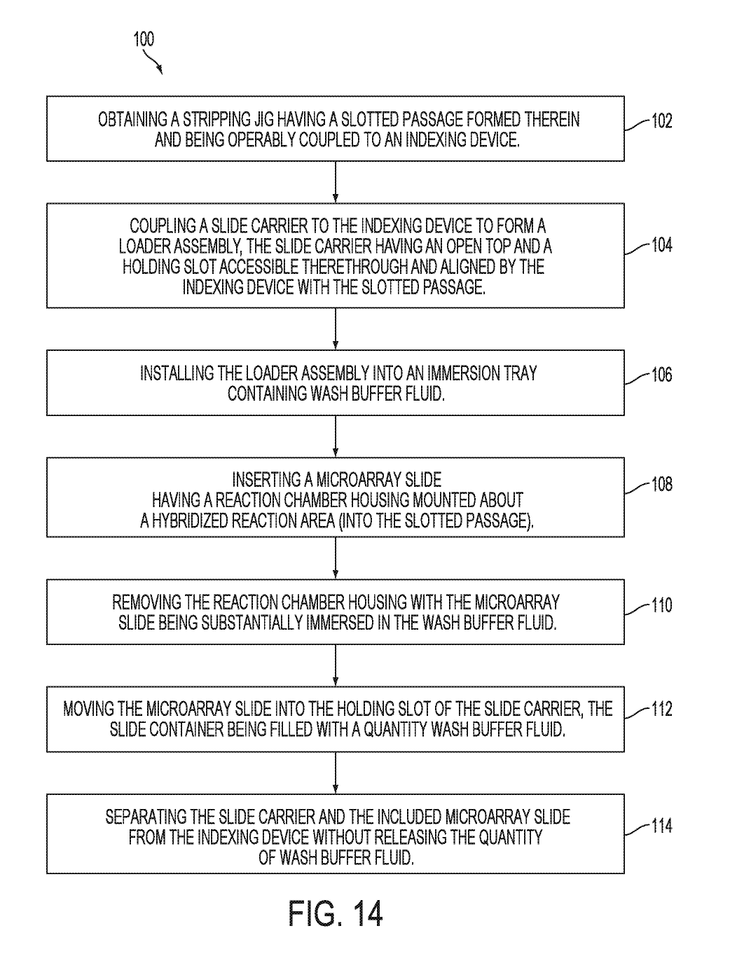

FIG. 14 is a flowchart depicting a method 100 of processing a microarray slide for washing in a slide conditioning system, in accordance with yet another representative embodiment. The method 100 can include the steps of the steps of obtaining 102 a stripping jig having a slotted passage formed therein and which is operably coupled to an indexing device, and coupling 104 a slide carrier to the indexing device to form a loader assembly, with the slide carrier having a bi-directional valve, an open top, and a holding slot accessible through the open top that is aligned with the slotted passage by the indexing device. The method also includes the steps of installing 106 the loader assembly into an immersion tray containing wash buffer fluid and inserting 108 the microarray slide having a reaction chamber housing mounted about the hybridized reaction area into the slotted passage. The method further includes removing 110 the reaction chamber housing while the microarray slide is substantially immersed in the wash buffer fluid, moving 112 the microarray slide into the slide carrier which is filled with a quantity wash buffer fluid, and separating 114 the slide carrier and the included microarray slide from the indexing device without releasing the quantity of wash buffer fluid.

It is to be understood that the above-described arrangements are only illustrative of the application of the principles of the present invention. Numerous modifications and alternative arrangements may be devised by those skilled in the art without departing from the spirit and scope of the present invention and the appended claims are intended to cover such modifications and arrangements. Thus, while the present invention has been described above with particularity and detail in connection with what is presently deemed to be the most practical and preferred embodiments of the invention, it will be apparent to those of ordinary skill in the art that numerous modifications, including, but not limited to, variations in size, materials, shape, form, function and manner of operation, assembly and use may be made without departing from the principles and concepts set forth herein.

What is claimed is:

1. A slide-loader system for preparing a microarray slide having a hybridized reaction area for washing, comprising:
an immersion tray containing a volume of wash buffer fluid;
a stripping jig holding the micro array slide during removal of a reaction chamber housing from about the hybridized reaction area;
a slide carrier having an open top and at least one holding slot accessible therethrough, the at least one holding slot receiving the microarray slide after removal of the reaction chamber housing;
an indexing device coupling the slide carrier to the stripping jig and aligning the micro array slide with the at least one holding slot;
wherein the indexing device, slide carrier and stripping jig together form a loader assembly installed into the immersion tray; and
wherein the microarray slide is substantially immersed in the wash buffer fluid during removal of the reaction chamber housing and insertion into the at least one holding slot in the slide carrier.

2. The slide-loader system of claim 1, further comprising a pump providing a continuous flow of wash buffer fluid over the hybridized reaction area of the microarray slide.

3. The slide-loader system of claim 2, wherein the pump is submersible and located within the immersion tray.

4. The slide-loader system of claim 1, wherein the at least one holding slot further comprises a plurality of parallel slots formed into the inside surfaces of the slide carrier.

5. The slide-loader system of claim 4, wherein the indexing device controls movement of the slide carrier in discrete increments relative to the stripping jig and guides each of a plurality of microarray slides into a separate parallel holding slot.

6. The slide-loader system of claim 1, further comprising a slide pusher for moving the microarray slide from the stripping jig into the slide container after removal of the reaction chamber housing.

7. The slide-loader system of claim 1, wherein the reaction chamber housing is attached about the hybridized reaction area of the microarray slide with an adhesive.

8. The slide-loader system of claim 1, wherein the stripping jig further comprises a slotted passage aligned by the indexing device with the at least one holding slot in the slide carrier, and having an open top face for accessing the top surface of the microarray slide.

9. The slide-loader system of claim 1, wherein the slide carrier further includes a bi-directional valve at a bottom end thereof.

10. A method of processing a microarray slide having a hybridized reaction area for washing in a slide conditioning system, comprising:
obtaining a stripping jig having a slotted passage formed therein and being operably coupled to an indexing device;
coupling a slide carrier to the indexing device to form a loader assembly, the slide carrier having an open top and at least one holding slot accessible therethrough aligned by the indexing device with the slotted passage;
installing the loader assembly into an immersion tray containing wash buffer fluid;
inserting at least one microarray slide into the slotted passage having a reaction chamber housing mounted about the hybridized reaction area;
removing the reaction chamber housing with the microarray slide being substantially immersed in the wash buffer fluid;
moving the microarray slide into the least one holding slot of the slide carrier, the slide container being filled with a quantity wash buffer fluid; and
separating the slide carrier and the included microarray slide from the indexing device without releasing the quantity of wash buffer fluid.

11. The method of claim 10, further comprising moving the slide carrier within the indexing device a discrete distance relative to the stripping jig and aligning at least one additional holding slot in the slide carrier with the slotted passage in the stripping jig.

12. The method of claim 11, further comprising processing at least one additional microarray slide having a hybridized reaction area while substantially immersed in the wash buffer fluid.

13. The method of claim 10, further comprising pumping a continuous flow of wash buffer fluid over the hybridized reaction area during removal of the reaction chamber housing.

14. The method of claim 10, wherein the slotted passage in the stripping jig further comprises an open-sided slotted passage providing access to the reaction chamber housing.

15. The method of claim 10, further comprising removing the loader assembly from the immersion tray prior to separating the slide carrier and the included microarray slide from the indexing device.

16. The method of claim 10, further comprising removably installing the slide carrier and the included microarray slide into a centrifugal slide conditioning system cradle.

17. A method of processing a microarray slide having a hybridized reaction area for washing in a slide conditioning system, comprising:
obtaining a stripping jig having a slotted passage formed therein for holding the microarray slide having a reaction chamber housing mounted about a hybridized reaction area;
operably coupling a slide carrier to the stripping jig, the slide carrier having an open top and at least one holding slot accessible therethrough and aligned with the slotted passage;
substantially submerging the slide carrier and coupled stripping jig in a immersion tray containing wash buffer fluid;
inserting at least one microarray slide into the slotted passage;
removing the reaction chamber housing with the microarray slide being substantially immersed in the wash buffer fluid;
moving the microarray slide into the holding slot of the slide carrier, the slide container being filled with a quantity of wash buffer fluid;
removing the slide carrier and coupled stripping jig from the immersion tray containing wash buffer fluid; and
separating the slide carrier and the included microarray slide from the stripping jig without releasing the quantity of wash buffer fluid.

18. The method of claim 17, further comprising moving the slide carrier a discrete distance relative to the stripping jig and aligning at least one additional holding slot in the slide carrier with the slotted passage in the stripping jig.

19. The method of claim 18, further comprising processing at least one additional micro array slide for washing in a slide conditioning system while substantially immersed in the wash buffer fluid.

20. The method of claim 17, further comprising pumping a continuous flow of wash buffer fluid over the exposed reaction surface of the microarray slide during removal of the reaction chamber housing.
